(19) United States
(12) Patent Application Publication
(10) Pub. No.: US 2023/0306044 A1
(43) Pub. Date: Sep. 28, 2023

(54) Systems and Methods for Numeric Network Extraction

(71) Applicant: Virtualitics, Inc., Pasadena, CA (US)

(72) Inventors: Sagar Indurkhya, Pasadena, CA (US); Héctor Javier Vázquez Martínez, Pasadena, CA (US); Alan Salimov, Pasadena, CA (US); Aakash Indurkhya, Pasadena, CA (US); Gennaro Zanfardino, Pasadena, CA (US); Evan Sloan, Pasadena, CA (US); Ciro Donalek, Pasadena, CA (US); Michael Amori, Pasadena, CA (US)

(73) Assignee: Virtualitics, Inc., Pasadena, CA (US)

(21) Appl. No.: 18/191,387

(22) Filed: Mar. 28, 2023

Related U.S. Application Data
(60) Provisional application No. 63/362,035, filed on Mar. 28, 2022.

(51) Int. Cl. G06F 16/28; G06F 16/22

(52) U.S. Cl. CPC G06F 16/287; G06F 16/2282; G06F 16/2237

(57) ABSTRACT

Systems and methods for extraction of network structures from tabular data structures having numeric features are described. One embodiment includes a method of extracting a network from a tabular data structure having numerical features, comprising obtaining a tabular data structure includes several records, where each record includes several numerical values each associated with a respective numerical feature, calculating pairwise similarities between records based on the several numerical values using a distance function, generating an edge list by sorting the pairwise similarities, extracting a subset of edges from the edge list based on a connectivity threshold, constructing a network structure by generating nodes from records and connecting said nodes using edges from the subset of edges, and visualizing the network structure using a display.

### CROSS-REFERENCE TO RELATED APPLICATIONS

The current application claims priority under 35 U.S.C. 119(e) to U.S. Provisional Patent Application No. 63/362,035, entitled “Systems and Methods for Numeric Network Extraction”, filed Mar. 28, 2022. The disclosure of U.S. Provisional Patent Application Ser. No. 63/362,035 is incorporated herein by reference in its entirety.

### FIELD OF THE INVENTION

This invention generally relates to the visualization of data, and to the extraction of network structures from in a tabular data containing both numerical and categorical features.

### BACKGROUND

Three-dimensional (3D) computer graphics are graphics that use a three-dimensional representation of geometric data stored in memory for the purposes of performing calculations and rendering 2D images. Conventional computer displays are capable of rendering a 2D image that gives the appearance of depth. Recently, Virtual Reality (VR) and Augmented Reality (AR) devices have been developed that simulate depth using stereoscopy, where different viewpoints of the same scene are displayed to the left and right eyes, such as the Vive, by HTC, or the Oculus Rift, by Oculus VR.

Data visualization using computer systems involves displaying data as a graphical representation of the data and is an important tool for data analysis. 3D computer graphic techniques have recently been used to try and represent large data sets in ways that are understandable by human users. Virtual reality has begun to be used to present 3D data to users.

Storing data in tabular data structures is a common practice. Common examples of data storage in tabular form include spreadsheets, comma-separated value (csv) files, and certain database formats. Tabular data structures are made up of rows and columns. Conventionally, each column (“feature” or “variable”) describes a type of variable, and each row (or “record”) describes a single entry that has values for each feature.

Network Graphs (sometimes simply referred to as “networks” or “graphs”) are a way of representing things and the relationships that exist between them. Networks are made of nodes and edges. Nodes can represent things from tangible objects to abstract ideas. Edges represent the relationships between nodes. Edges can have a weight which represent the strength of the relationship between the two nodes the edge connects.

### SUMMARY OF THE INVENTION

Systems and methods for data visualization and network extraction in accordance with embodiments of the invention are illustrated. One embodiment includes a method of extracting a network from a tabular data structure having numerical features, comprising obtaining a tabular data structure includes several records, where each record includes several numerical values each associated with a respective numerical feature, calculating pairwise similarities between records based on the several numerical values using a distance function, generating an edge list by sorting the pairwise similarities, extracting a subset of edges from the edge list based on a connectivity threshold, constructing a network structure by generating nodes from records and connecting said nodes using edges from the subset of edges, and visualizing the network structure using a display.

In a further embodiment, the distance function is Cosine Similarity.

In still another embodiment, the distance function is Euclidean Distance.

In a still further embodiment, the numerical features are independently standard scaled to have unit mean and variance.

In yet another embodiment, extracting a subset of edges from the edge list based on the connectivity threshold comprises storing the pairwise similarities in a matrix X, sampling X to generate X\hat{ }based on a sampling parameter, multiplying X\hat{ } with its transpose, calculating a number of desired edges,

$$e = \frac{c ( n ) ( n - 1 )}{2} ,$$

where c is the connectivity threshold, and n is the number of records, and extracting a subset of e edges from the edge list.

In a yet further embodiment, the sampling parameter is between 1% and 8%.

In another additional embodiment, the connectivity threshold is between 0.2% and 2%.

In a further additional embodiment, the method further includes steps for evaluating the network structure by calculating a Kolmogorov-Smirnov ratio.

Another embodiment includes a system for extracting a network from a tabular data structure having numerical features, comprising a processor, and a memory, the memory containing a data visualization application that configures the processor to obtain a tabular data structure includes several records, where each record includes several numerical values each associated with a respective numerical feature, calculate pairwise similarities between records based on the several numerical values using a distance function, generate an edge list by sorting the pairwise similarities, extract a subset of edges from the edge list based on a connectivity threshold, and construct a network structure by generating nodes from records and connecting said nodes using edges from the subset of edges, and visualize the network structure using a display.

In another embodiment again, the distance function is Cosine Similarity.

In a further embodiment again, the distance function is Euclidean Distance.

In still yet another embodiment, the numerical features are independently standard scaled to have unit mean and variance.

In a still yet further embodiment, to extract a subset of edges from the edge list based on the connectivity threshold, the data visualization application further configures the processor to store the pairwise similarities in a matrix X, sample X to generate X\hat{ }based on a sampling parameter, multiply X\hat{ } with its transpose, calculate a number of desired edges,

$$e = \frac{c ( n ) ( n - 1 )}{2} ,$$

where c is the connectivity threshold, and n is the number of records, and extract a subset of e edges from the edge list.

In still another additional embodiment, the sampling parameter is between 1% and 8%.

In a still further additional embodiment, the connectivity threshold is between 0.2% and 2%.

In still another embodiment again, the data visualization application further configures the processor to calculate a Kolmogorov-Smirnov ratio in order to evaluate the network structure.

Yet another embodiment includes a method of extracting a network from a tabular data structure having numerical features, comprising obtaining a tabular data structure includes several records, where each record includes several numerical values each associated with a respective numerical feature, initializing a KMeans algorithm with a distance function, generating K clusters using the KMeans algorithm until convergence, for each cluster calculating pairwise similarities between records based on the several numerical values using the distance function, generating an edge list by sorting the pairwise similarities, extracting a subset of edges from the edge list based on a connectivity threshold, initializing the KMeans algorithm such that centroids use points farthest from each cluster centroid, running the KMeans algorithm over the K clusters to produce a new set of clusters, for each of the new set of clusters calculating pairwise similarities between records based on the several numerical values using the distance function, generating an edge list by sorting the pairwise similarities, and extracting a subset of edges from the edge list based on a connectivity threshold, compose the subset of edges from each cluster, select the top number of edges from the composition of edges based on the connectivity threshold to generate a final edge list, construct a final network structure using the several records as nodes, connected by edges in the final edge list, and visualize the final network structure using a display.

In a still further embodiment again, the distance function is Cosine Similarity.

In yet another additional embodiment, the distance function is Euclidean Distance.

In a yet further additional embodiment, the method further includes steps for evaluating the network structure by calculating a Kolmogorov-Smirnov ratio.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

FIG. 1 is a network diagram for a data visualization system in accordance with an embodiment of the invention.

FIG. 2 conceptually illustrates a data visualization system implemented on a single computing device in accordance with an embodiment of the invention.

FIG. 3 is a flowchart illustrating a data visualization process for numeric network extraction in accordance with an embodiment of the invention.

FIG. 4 is a flowchart illustrating a process for efficiently performing numeric network extraction on large datasets in accordance with an embodiment of the invention.

### DETAILED DESCRIPTION

3D data visualization systems are built to enable users to understand their data in intuitive, visual ways. By interacting with data visually, the human mind is capable of using its significant pattern recognition abilities to make sense of data. However, 3D rendering, and especially rendering images for Virtual Reality (VR), Augmented Reality (AR), and Mixed Reality (MR) systems takes a significant amount of computing power. In the age of Big Data, data sets that are increasingly large and complex are becoming both invaluable and readily available. However, as the complexity and volume of a dataset increases, so too does the processing power required to visualize the data.

This issue presents multiple challenges for the effective usage and visualization of data, many of which are discussed in U.S. Pat. No. 10,621,762, entitled “Systems and Methods for High Dimensional 3D Data Visualization”, granted Apr. 14, 2020, the entirety of which is hereby incorporated by reference. One form of data visualization is representation of data in the form of a network. Networks are graphs which represent data via sets of nodes and the edges that connect the nodes. Networks are a useful representation for interpreting data as the network structure can provide insights to users. Many databases, however, store data in tables, referred to as a tabular data structure. Extracting a network refers to the process of converting a tabular data structure to a network data structure. Systems and methods for extracting networks are preliminarily discussed in U.S. Pat. No. 11,481,939, titled “Systems and Methods for 3D Data Visualization and Network Extraction” filed Jan. 25, 2021, the disclosure of which is hereby incorporated by reference in its entirety.

Many tabular data structures include a mixture of categorical features (sometimes referred to as “qualitative variables”) and numerical features (sometimes referred to as “quantitative variables”). Extraction of networks from the numerical features in a tabular data structure poses a particular challenge. Categorical features typically have a finite number of values, and therefore different records can often have exact categorical feature value matches. This makes it easier to infer a relationship between two records. With numerical features, in many instances, an infinite range of values is permissible, and it can be difficult for a computer to autonomously determine relationships between records where numerical feature values are not exact.

Systems and methods describe herein extend network extraction to take numeric features as input and produce a network data structure from them. In numerous embodiments, the extraction process includes capturing relationships between nodes with one or more similar, but not identical, numerical values. In many embodiments, the relationship between the numerical values assigned to two nodes can be quantified by computing the Euclidean and/or the Cosine Similarity, depending on the input features to generate an affinity matrix. Two data points will be similar if their features are located in similar spaces—a similarity value (or ‘metric’) can be used to quantify this. A threshold can be used to enforce a desired connectivity on the graph. In numerous embodiments, as a general-purpose starting value, the desired connectivity for most people tends to be around 2%. That is, of all possible edges between nodes, only 2% are shown. However, as can readily be appreciated, the desired connectivity can radically be altered depending on the desires of the user, typically between 1%-10%. In numerous embodiments, the network is then generated using pairwise comparisons using the appropriate distance function. Sampling can be implemented to reduce the number of comparisons needed. Since the space and time of pairwise comparisons and the resultant matrix scales quadratically, K-Means can be used to speed up computation on large networks, minimizing the size of the matrices to prevent time and space issues.

In numerous embodiments, once the network has been generated, a hybrid Markov and Louvain community detection algorithm (for example, the algorithm found in U.S. Pat. No. 11,481,939) is applied to cluster the nodes, and the resulting clusters are evaluated for visual, logical, and statistical significance. For many people, an ideal graph has a structure with easily distinguishable clusters to aid human readability. Further, the clusters themselves should have some distinguishing characteristics with respect to certain features. For example, a certain cluster may have an above average amount of some protein expression that corresponds to a grouping of cells. Data visualization systems capable of numeric network extraction are described in further detail below, followed by a discussion of methods for numeric network extraction.

Data Visualization Systems

Data visualization systems can be implemented using a variety of architectures, from single computing devices to distributed computing systems. In numerous embodiments, multiple user interface devices can be connected to enable multiple users to interact with the data and with each other in a virtual environment. In many embodiments, the distribution of computational activity is dependent upon the number of users interacting with the visualization.

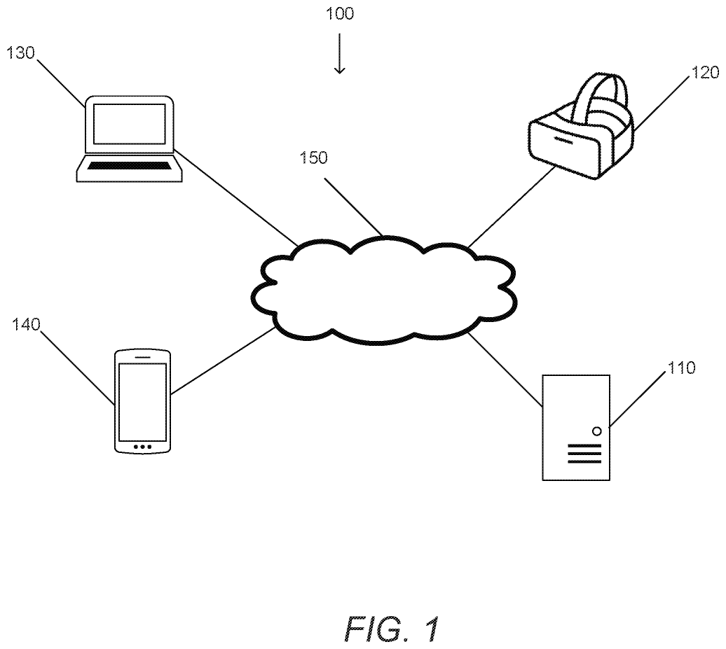

A data visualization system in accordance with an embodiment of the invention is illustrated in FIG. 1. Data visualization system 100 includes a data visualizer 110. Data visualizers can be implemented using a variety of different hardware. For example, personal computers, servers, server systems (e.g. cloud computing architectures), could be used as a Data visualizer. In numerous embodiments, Data visualizers can leverage distributed computer hardware. Data visualizers can perform data visualization processes including, but not limited to, those discussed in below sections.

Data visualization system 100 further includes a number of user interface devices, such as a VR display 120, a computer terminal 130, and smartphone 140. Example VR displays can be, but are not limited to, VR headsets such as the Oculus Rift, HTC Vive, or the Google Cardboard, AR displays such as the Microsoft Hololens, and/or MR displays such as Windows Mixed Reality Headsets. In many embodiments, user interface devices include a display capable of rendering high dimensional data in accordance with data visualization processes. In a variety of embodiments, user interface devices enable users to set visualization parameters, manipulate the view point of the visualization, and/or access generated insights. Data visualization systems can provide different viewpoints of the same visualization to each connected user interface device, and/or provide the same viewpoint to two or more user interface devices.

Data visualizer 100 is connected to interface devices via a network 150. Network 150 can be a wired network, a wireless network, or a combination of both wired and wireless networks. In many embodiments, networks include (but are not limited to) wide area networks, local area networks, personal area networks, the Internet, or any other communication protocol and/or network architecture as appropriate to the requirements of specific applications of embodiments of the invention.

As can be readily appreciated, and number of architectures can be used, such as, but not limited to, architectures that involved distributed computing platforms, different numbers of user interface devices, and/or any other implementation that may be appropriate to the requirements of a given application. Data visualizers are discussed in further detail below.

Data Visualizers

As noted above, data visualizers are capable of performing data visualization processes. While below is a discussion of an exemplary data visualization system implemented using a single computing device, in numerous embodiments, Data visualizers are implemented using distributed architectures. The specific architecture can change based on the processing power required and the number of users that are designed to interact with the system.

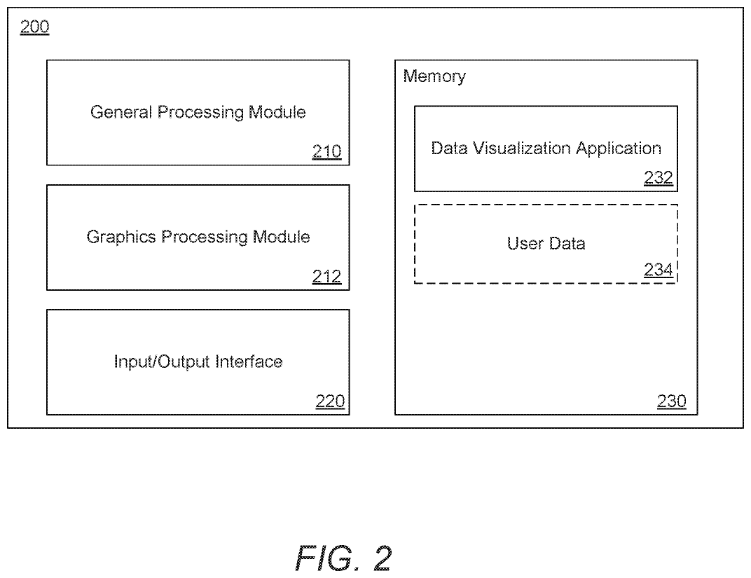

A data visualizer implemented on a single computing device in accordance with an embodiment of the invention is illustrated in FIG. 2. Data visualizer 200 includes a general processing module 210 and a graphics processing module 212. In numerous embodiments, general processing modules are general purpose processors such as a Central Processing Unit (CPU). Graphics processing modules are processors architected to excel at numerous, parallelizable functions such as rendering images including, but not limited to, GPUs. In some embodiments, general processing module 210 and graphics processing module 212 can be implemented using the same processing circuitry and/or using more than two processing components. As can readily be appreciated, Data visualizers can take advantage of the capabilities of different processor configurations to optimize computational resources. For example, some data visualizers may only leverage central processing modules.

Data visualizer 200 includes an input/output (I/O) interface 220. I/O interface can connect to user interface devices such as a VR headset, or a 2D display. In numerous embodiments, displays can be completely integrated into the data visualizer. In many embodiments I/O interfaces enable communications with distributed computing hardware, the acquisition of user data to visualize, and/or obtaining visualization parameters. As can be readily appreciated, any number of I/O circuitries can be used, including multiple types of I/O interfaces that are specialized for communication with different types of devices.

Data visualizer 200 further includes a memory 230. Memory 230 can be any type of memory, such as (but not limited to) volatile memory, non-volatile memory, or any combination thereof. Memory 230 contains a data visualization application 232. Data visualization applications can configure general processing modules and graphics processing modules to perform data visualization processes. In many embodiments, data visualization applications can determine what hardware is available, and optimize performance of the data visualization application by utilizing specialized data structures that can take advantage of different hardware. Memory 230 can further include user data 234 acquired from a user interface device. In numerous embodiments, the user data contains a tabular data structure having at least numeric features. As can be readily appreciated, additional memory can be incorporated into the system. For example, in various embodiments, the GPU may have dedicated memory separate from memory 230 such as (but not limited to) video random access memory (VRAM). In some embodiments, the GPU may have a dedicated portion of memory 230.

As can readily be appreciated, any number of system designs can be used to enable a computer system to perform numeric network extraction. For example, in numerous embodiments, Data visualizers may include multiple general processing modules and/or graphics processing modules, and/or be spread across a cloud computing network. Data visualization processes for numeric network extraction are described in further detail below.

Numeric Network Extraction

Numeric network extraction (NNE) is the process of generating a network data structure from a tabular data structure that contains numeric features. Unlike categorical variables where exact matches are relatively common, it can be much more difficult to determine how closely related two values are. The NNE algorithm extracts these relationships between different values as edges, and uses the edges to create a graph structure which can then be processed for visualization in accordance with the systems and methods described in U.S. Pat. No. 11,481,939.

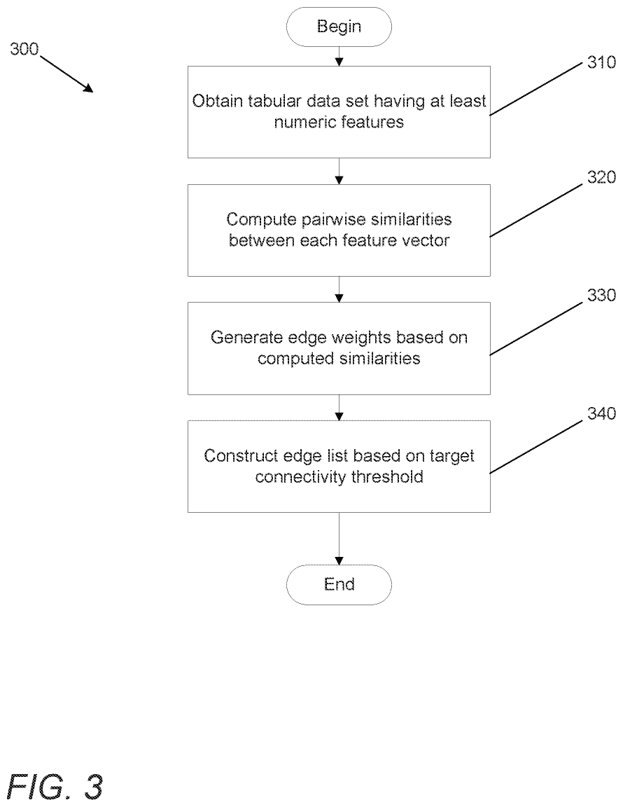

Turning now to FIG. 3, a flowchart showing the NNE algorithm in accordance with an embodiment of the invention is illustrated. Process 400 includes obtaining (310) a tabular data set having numeric features. Pairwise similarities between each feature vector are calculated (320). In this case, a “feature vector” is a vector containing the numerical values for the numerical features of interest for a given record. In many embodiments, Euclidean Distance is used to calculate pairwise similarity. In various embodiments, Cosine Similarity is used to calculate pairwise similarity. However, any number of different similarity calculations can be used as appropriate to the requirements of specific applications of embodiments of the invention. Edge weights are generated (330) based on the computed similarities. An edge list is then constructed (340) using the edge weights and a target connectivity threshold. The target connectivity threshold is a variable which indicates the percentage of nodes that should be connected by edges. In terms of human readability, too many edges can result in a visually incomprehensible mesh. In numerous embodiments, the target connectivity threshold is approximately 2%, although this number can be modified depending on the size of the data set. For example, with significantly large datasets, this number may be reduced by an order of magnitude or more. The edge list in conjunction with the associated records represent a network graph structure.

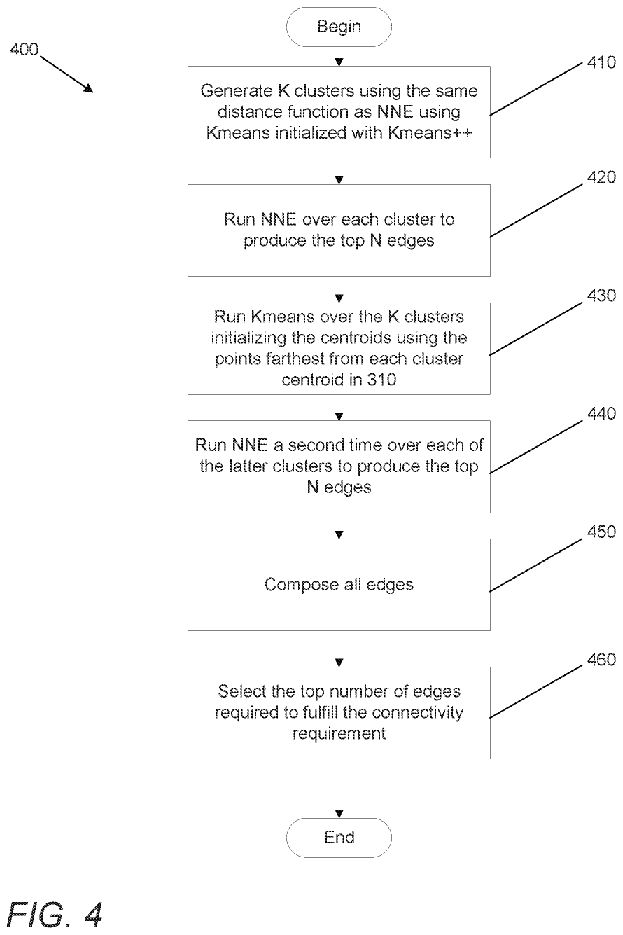

NNE can be formalized mathematically. To begin, Fₛ(M) is a pairwise similarity function that takes any matrix M of any N features, and returns a matrix where each entry is the similarity between each feature set. In many embodiments, the similarity function is Euclidean Distance or Cosine Similarity, although other distance metrics can be used as appropriate to the requirements of specific applications of embodiments of the invention. F_{E}(G) is a community detection algorithm that is a weight sensitive hybrid of Markov and Louvain Community Detection that optimizes for a high modularity. An example community detection algorithm is described in U.S. Pat. No. 11,481,939, in particular at FIG. 4 and surrounding discussion. X∈R^{n×m}: X is the notation for the real-valued feature matrix, where each row is a data point and each column is a numeric feature, where n refers to the number of data points, and m refers to the number of features. c is a target threshold for connectivity expressed as a percentage reflecting the overall desired connectivity of the network. For most use cases, 2% is a reasonable target threshold when desiring human readability, however this number can be moved up or down depending on the size and type of data, and the desires of an end user.

Using the above, NNE can be formalized as the following steps:
1)

$$X ← \{ \frac{{X}_{i} - {μ}_{{X}_{i}}}{{σ}_{{X}_{i}}} \vert i ∈ m \} .$$

All features are standard scaled, independently of each other, to have unit mean and variance. For certain datasets, this can be skipped.
2)

$$X ← \{ \frac{{X}^{( j )}}{‖ {X}^{( j )} ‖} \vert j ∈ n \} .$$

In many embodiments, if Cosine Similarity is being used, then all rows are normalized to have unit length after scaling.
3) Sample X to generate X\hat{ }. In many embodiments, the sample is taken at 2%, although depending on the data set the sample can be taken between 1%-8%.
4) A←X\hat{ }X\hat{ }^{T}, where the transformed sampled feature matrix is multiplied with its transpose.
5) If Euclidean distance is used: A\hat{ }←diag(A\hat{ })1+1diag(A\hat{ })−2A\hat{ }. This reflects a quadratic expansion of the Euclidean distance trick using matrix operations.
6) Calculate the number of edges, e, need to have the desired connectivity, by:

$$e = \frac{c ( n ) ( n - 1 )}{2} ,$$

where c is the desired connectivity. Typically, c is around 2% of total possible edges for the target. For graphs with more than 50,000 nodes, the connectivity may be lowered by an order of magnitude to enhance human readability to approximately 0.2%. As the number of nodes increases, connectivity may be tuned down even further.
7) Multiply e by a sampling parameter sₚ and sort the first eₛ edges of A. To get the soft threshold Tₛ, select the S_{T}←k*(c)*(e)th weight, where k is a constant between 1 and 10, and only add edges to the intermediate edge list above this value. In many embodiments, sₚ is a number between 0 and 1. Typically, sₚ is between 0.1 and 0.2, although it can be moved towards zero to speed up processing time and yield a sparser network. In various embodiments, sₚ can be automatically scaled inversely to the number of records in the tabular data structure (e.g. less data, higher sₚ).
8) Perform a pairwise calculation over all edges using a parallel implementation. In many embodiments, the parallel implementation is implemented using a flat loop by calculating, for each integer from 0 . . . (num rows)(num rows−1), determining indices i and j as:

$$i = \frac{index}{num rows} and j = index ( mod num rows ) .$$

In many embodiments, only indices in the upper triangle are considered.
9) Sort and select the top e edges as the true threshold T, and add only edges above T to the graph. This turns the graph from a complete graph to an appropriately connected graph.

In many embodiments, where the graph size exceeds approximately 200,000 nodes, KMeans² is applied in conjunction with NNE to reduce computational burden significantly such that modest laptops can perform the process as opposed to a full server or cluster. Turning now to FIG. 4, a process for using KMeans to reduce computational burden for large data sets in accordance with an embodiment of the invention is illustrated. Process 400 includes using Elkan's KMeans algorithm with KMeans++initialization and the same distance function indicated for the instance's NNE to generate (410) K clusters, where

$$K = 2 ( \frac{num nodes + M - 1}{M} ) ,$$

and M is a constant set to a value such that the size of cluster K is roughly 5000-8000 nodes. This is performed until convergence. Elkan's KMeans is described in Jain, B. J., Obermayer, K. (2010). Elkan's k-Means Algorithm for Graphs. In: Sidorov, G., Hernandez Aguirre, A., Reyes Garcia, C. A. (eds) Advances in Soft Computing. MICAI 2010. Lecture Notes in Computer Science, vol 6438. Springer, Berlin, Heidelberg. The NNE algorithm, including sampling, is ran (420) over each resulting cluster to yield the top N edges. KMeans is once again run (430) over K clusters, this time initializing the centroids using the points farthest from each cluster centroid in step 410. NNE is then run (440), including sampling, over each of the latter clusters, returning the top N edges. All of the edges are composed (450) and the top number edges from the composition of edges required to fulfil the connectivity threshold are selected (460) as the edge list for generating the network graph.

In many embodiments, by clustering both in the KMeans++initialized means as well as the points farther from the first cluster centers, the interstitial spaces between the generated clusters are explored and clusters can be connected to each other. The time complexity of a matrix multiplication in practice has a lower bound of Ω(n2.8). The above algorithm manages to accomplish network extraction much faster, in O(n2), where n is the number of nodes in the network. There is also a significant lessening of memory requirements compared to the quadratic growth of full matrix multiplication.

Measuring distance is a key part of NNE. Two main similarity metrics are discussed above: Euclidean Distance, and Cosine Similarity. Euclidean Distance measures the sum of the squared distance between two feature vectors. Euclidean Distance can be inverted to convert it into a similarity metric where higher values indicate more similar nodes. This is formalized as:

$$d ( p , q ) = \frac{1}{1 + \sqrt{{\sum }_{i ∈ \{ 1 … m \}} {( {p}_{i} - {q}_{i} )}^{2}}}$$

Cosine similarity takes the dot product of unit normalized nodes:

$$d ( p , q ) = \frac{p \cdot q}{‖ p ‖ ‖ q ‖} .$$

The Cosine Similarity metric has the characteristic of dropping magnitudes for features, which changes the resultant graph. This can be desirable if the magnitude of a certain feature is less important than its ratio to other features. For example, a dinner recipe for four people versus twenty people is more similar to each other than a dessert recipe for four people. That said, the converse can be true as well. In order to determine whether to use Euclidean Distance or Cosine Similarity, a heuristic can be used. In many embodiments, if the variance of a certain distribution of similarities is low, that is, all of the points are tightly clustered in space, then Cosine Similarity is used to distinguish between them. While these two distance metrics are discussed, as can readily be appreciated other methods of calculating distance can be used without departing from the scope or spirit of the invention. For example, kernel methods such as the Radial Basis Function Kernel can provide a well-defined similarity score. Similarly, different heuristics can be applied depending on the end user's goals.

After NNE has been performed to produce a network graph, community detection and visualization can be performed in accordance with the processes similar to those discussed in U.S. Pat. No. 11,481,939. Once communities are calculated within the graph, the network extraction can be evaluated. In many embodiments, the top N largest communities are selected and used to calculate modularity and the ratio of statistically significant feature-community pairs as evaluation metrics. In many embodiments, the evaluation metrics include at least one of: a modularity score; Kolmogorov-Smirnov (KS) Ratio; and an evaluation score. However, other methods can be used to evaluate performance.

Modularity Score: Modularity is the difference between the number of edges per node within a community and the number of edges per node that would exist if the edges were distributed at random across the whole graph. Modularity is bounded by −0.5 and 1, where 1 is a very well separated graph. The modularity score can be formalized as:

$$Q = \frac{1}{2 m} {\sum }_{ij} ( {A}_{ij} - \frac{{k}_{i} {k}_{j}}{2 m} ) δ ( {c}_{i} , {c}_{j} )$$

where A is the adjacency matrix, kᵢ is the degree of i, and δ is 1 if both nodes are in the same community, otherwise it is 0. The modularity can be averaged for all communities and be presented as representation of the visual suitability of the graph.

KS Ratio: The Kolmogorov-Smirnov 2-sample statistical test can be used to evaluate the descriptive power of NNE. KS Ratio is particularly valuable as it is a reliable non-parametric test which can be broadly applied to many datasets. To create an evaluation metric, for each community and numeric feature, it can be determined whether or not that community contains a statistically significant difference in distribution of that feature versus overall. In numerous embodiments, statistical significance is determined by a corrected alpha. Networks with a higher KS Ratio have quantifiably more insights, and yield more descriptive power.

The KS statistic refers to the distance between the empirical distribution function of one sample, and either the CDF or the empirical distribution function of another sample. In many embodiments, a cluster of interest is the first sample, and the overall values for that feature from the entire dataset is the second sample:

$${F}_{n} ( x ) = \frac{num elements \leq x}{n}$$

$${D}_{n , m} = {sup}_{x} \vert {F}_{1 , n} ( x ) - {F}_{2 , m} ( x ) \vert$$

where n is the sample size, supₓ is the suprenum function; the statistic is the largest absolute difference between the two samples for all sample values x. In numerous embodiments, running this test over a dataset shows, for each cluster, which feature has a significantly significant deviation from the average distribution of that feature over the entire dataset. In various embodiments, when the data set is so large as to be too computationally expensive to run over the entire dataset, sampling can be used to get a reasonable subset to test. The size of the sample can be determined by a statistical power test.

Evaluation score: to create a single score to measure the efficacy of each method, the geometric mean of modularity and KS Ratio can be used to evaluate how well each method performs. However, any number of different statistical processes can be used to evaluate performance as appropriate to the requirements of specific applications of embodiments of the invention.

While particular methods for NNE are discussed above, modifications can be made in order to enable additional functionalities such as enabling hybrid dataset network extraction, i.e. tabular datasets containing both numerical and categorical values. Further, although specific systems and methods for numeric network extraction are described herein, many different system architectures and visualization methods can be implemented in accordance with many different embodiments of the invention. It is therefore to be understood that the present invention may be practiced in ways other than specifically described, without departing from the scope and spirit of the present invention, for example, by performing steps in the processes in different orders, in parallel, and/or with added, subtracted, and/or substitute steps. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method of extracting a network from a tabular data structure having numerical features, comprising:
obtaining a tabular data structure comprising a plurality of records, where each record comprises a plurality of numerical values each associated with a respective numerical feature;
calculating pairwise similarities between records based on the plurality of numerical values using a distance function;
generating an edge list by sorting the pairwise similarities;
extracting a subset of edges from the edge list based on a connectivity threshold;
constructing a network structure by generating nodes from records and connecting said nodes using edges from the subset of edges; and
visualizing the network structure using a display.

2. The method of extracting a network from a tabular data structure having numerical features of claim 1, wherein the distance function is Cosine Similarity.

3. The method of extracting a network from a tabular data structure having numerical features of claim 1, wherein the distance function is Euclidean Distance.

4. The method of extracting a network from a tabular data structure having numerical features of claim 1, wherein the numerical features are independently standard scaled to have unit mean and variance.

5. The method of extracting a network from a tabular data structure having numerical features of claim 1, wherein extracting a subset of edges from the edge list based on the connectivity threshold comprises:
storing the pairwise similarities in a matrix X;
sampling X to generate X\hat{ } based on a sampling paramaeter;
multiplying X\hat{ } with its transpose;
calculating a number of desired edges,
$$e = \frac{c ( n ) ( n - 1 )}{2} ,$$
where c is the connectivity threshold, and n is the number of records; and
extracting a subset of e edges from the edge list.

6. The method of extracting a network from a tabular data structure having numerical features of claim 5, wherein the sampling parameter is between 1% and 8%.

7. The method of extracting a network from a tabular data structure having numerical features of claim 5, wherein the connectivity threshold is between 0.2% and 2%.

8. The method of extracting a network from a tabular data structure having numerical features of claim 1, further comprising evaluating the network structure by calculating a Kolmogorov-Smirnov ratio.

9. A system for extracting a network from a tabular data structure having numerical features, comprising:
a processor; and
a memory, the memory containing a data visualization application that configures the processor to:
obtain a tabular data structure comprising a plurality of records, where each record comprises a plurality of numerical values each associated with a respective numerical feature;
calculate pairwise similarities between records based on the plurality of numerical values using a distance function;
generate an edge list by sorting the pairwise similarities;
extract a subset of edges from the edge list based on a connectivity threshold; and
construct a network structure by generating nodes from records and connecting said nodes using edges from the subset of edges; and
visualize the network structure using a display.

10. The system for extracting a network from a tabular data structure having numerical features of claim 9, wherein the distance function is Cosine Similarity.

11. The system for extracting a network from a tabular data structure having numerical features of claim 9, wherein the distance function is Euclidean Distance.

12. The system for extracting a network from a tabular data structure having numerical features of claim 9, wherein the numerical features are independently standard scaled to have unit mean and variance.

13. The system for extracting a network from a tabular data structure having numerical features of claim 9, wherein to extract a subset of edges from the edge list based on the connectivity threshold, the data visualization application further configures the processor to:
store the pairwise similarities in a matrix X;
sample X to generate X\hat{ }based on a sampling paramaeter;
multiply X\hat{ } with its transpose;
calculate a number of desired edges,
$$e = \frac{c ( n ) ( n - 1 )}{2} ,$$
where c is the connectivity threshold, and n is the number of records; and
extract a subset of e edges from the edge list.

14. The system for extracting a network from a tabular data structure having numerical features of claim 13, wherein the sampling parameter is between 1% and 8%.

15. The system for extracting a network from a tabular data structure having numerical features of claim 13, wherein the connectivity threshold is between 0.2% and 2%.

16. The system for extracting a network from a tabular data structure having numerical features of claim 9, wherein the data visualization application further configures the processor to calculate a Kolmogorov-Smirnov ratio in order to evaluate the network structure.

17. A method of extracting a network from a tabular data structure having numerical features, comprising:
obtaining a tabular data structure comprising a plurality of records, where each record comprises a plurality of numerical values each associated with a respective numerical feature;
initializing a KMeans algorithm with a distance function;
generating K clusters using the KMeans algorithm until convergence;
for each cluster:
calculating pairwise similarities between records based on the plurality of numerical values using the distance function;
generating an edge list by sorting the pairwise similarities;
extracting a subset of edges from the edge list based on a connectivity threshold;
initializing the KMeans algorithm such that centroids use points farthest from each cluster centroid;
running the KMeans algorithm over the K clusters to produce a new set of clusters;
for each of the new set of clusters:
calculating pairwise similarities between records based on the plurality of numerical values using the distance function;
generating an edge list by sorting the pairwise similarities; and
extracting a subset of edges from the edge list based on a connectivity threshold;
compose the subset of edges from each cluster;
select the top number of edges from the composition of edges based on the connectivity threshold to generate a final edge list;
construct a final network structure using the plurality of records as nodes, connected by edges in the final edge list; and
visualize the final network structure using a display.

18. The method of extracting a network from a tabular data structure having numerical features of claim 17, wherein the distance function is Cosine Similarity.

19. The method of extracting a network from a tabular data structure having numerical features of claim 17, wherein the distance function is Euclidean Distance.

20. The method of extracting a network from a tabular data structure having numerical features of claim 17, further comprising evaluating the network structure by calculating a Kolmogorov-Smirnov ratio.
